(19) United States
(12) Patent Application Publication
(10) Pub. No.: US 2022/0115648 A1
(43) Pub. Date: Apr. 14, 2022

(54) NONAQUEOUS ELECTROLYTE SECONDARY BATTERY

(71) Applicant: Prime Planet Energy & Solutions, Inc., Tokyo (JP)

(72) Inventors: Ryo HANAZAKI, Kobe-shi (JP); Keiichi TAKAHASHI, Nishinomiya-shi (JP)

(21) Appl. No.: 17/496,724

(22) Filed: Oct. 7, 2021

(30) Foreign Application Priority Data
Oct. 12, 2020 (JP) 2020-172046

(51) Int. Cl. H01M 4/36; H01M 4/505; H01M 4/525

(52) U.S. Cl. CPC H01M 4/366; H01M 2004/021; H01M 4/525; H01M 4/505

(57) ABSTRACT

A nonaqueous electrolyte secondary battery includes: a positive electrode; a negative electrode; and an electrolyte. The positive electrode includes a positive electrode substrate and a positive electrode active material layer. The positive electrode active material layer is disposed on a surface of the positive electrode substrate. The positive electrode active material layer includes a first layer and a second layer. The second layer is disposed between the first layer and the positive electrode substrate. The first layer includes single-particles. The second layer includes aggregated particles.

This nonprovisional application is based on Japanese Patent Application No. 2020-172046 filed on Oct. 12, 2020, with the Japan Patent Office, the entire contents of which are hereby incorporated by reference.

### BACKGROUND OF THE INVENTION

### Field of the Invention

The present disclosure relates to a nonaqueous electrolyte secondary battery.

### Description of the Background Art

Japanese Patent Laying-Open No. 2019-021627 discloses a positive electrode material in which a ratio of single crystal particles and secondary particles is adjusted.

### SUMMARY OF THE INVENTION

A nonaqueous electrolyte secondary battery (hereinafter, also simply referred to as “battery”) includes positive electrode active material particles. Generally, each of the positive electrode active material particles is an aggregated particle. That is, the positive electrode active material particle is a secondary particle obtained by aggregation of a multiplicity of primary particles. In response to charging and discharging of the battery, each of the primary particles is expanded and contracted. Therefore, a crack tends to be progressed along a grain boundary between the primary particles. The progress of crack may lead to crushing of a positive electrode active material particle. As a result, cycle life may be decreased.

A single-particle has been also known as a particle form of the positive electrode active material particle. The single-particle is a primary particle grown to be comparatively large. The single-particle exists solely or forms a small number of aggregates. In the single-particle, a crack tends to be less likely to be generated. This is presumably because there are a small number of grain boundaries. By using such single-particles, it is expected to improve the cycle life.

However, in the single-particle, diffusion resistance for lithium (Li) ions tends to be large. The use of the single-particles may lead to decreased input performance.

An object of the present disclosure is to improve a balance between input performance and a cycle life.

Hereinafter, the technical configuration, function and effect of the present disclosure will be described. However, the mechanism of the function of the present disclosure includes a presumption. The scope of claims is not limited by whether or not the mechanism of the function is correct.

[1] A nonaqueous electrolyte secondary battery includes: a positive electrode; a negative electrode; and an electrolyte. The positive electrode includes a positive electrode substrate and a positive electrode active material layer. The positive electrode active material layer is disposed on a surface of the positive electrode substrate. The positive electrode active material layer includes a first layer and a second layer. The second layer is disposed between the first layer and the positive electrode substrate. The first layer includes a first particle group as a main active material. The second layer includes a second particle group as a main active material. The first particle group consists of a plurality of first positive electrode active material particles. The second particle group consists of a plurality of second positive electrode active material particles. Each of the first positive electrode active material particles includes 1 to 10 single-particles. Each of the second positive electrode active material particles is a secondary particle obtained by aggregation of 50 or more primary particles.

According to a new finding of the present disclosure, it is expected to improve a balance between input performance and a cycle life by attaining a specific distribution of the single-particles and the aggregated particles in the thickness direction of the positive electrode active material layer.

The positive electrode active material layer of the present disclosure includes the first layer and the second layer. The first layer is a layer that mainly includes the single-particles. The second layer is a layer that mainly includes the aggregated particles. The second layer is disposed on the positive electrode substrate side with respect to the first layer. In other words, the first layer is an upper layer and the second layer is a lower layer. During charging/discharging, reactions tend to occur intensively at the upper layer. Therefore, a crack tends to be likely to be generated in the positive electrode active material particles in the upper layer. In the positive electrode active material layer of the present disclosure, the single-particles are collectively located in the upper layer. It is considered that a crack is less likely to be generated in each of the single-particles. Since the single-particles are collectively located in the upper layer, the cycle life is expected to be improved.

In the positive electrode active material layer of the present disclosure, the aggregated particles are collectively located in the lower layer. Normally, each of the aggregated particles tends to be likely to be crushed. However, the aggregated particles disposed in the lower layer tends to be less likely to be crushed. This is presumably because reactions tend to progress moderately during charging/discharging in the lower layer as compared with the upper layer. Each of the aggregated particles has a relatively large surface area. Further, in each primary particle included in the aggregated particle, the diffusion resistance for the Li ions tends to be small. Since diffusion of the Li ions is promoted in the lower layer, the input performance is expected to be improved.

In the manner described above, in the battery of the present disclosure, the balance between the input performance and the cycle life is expected to be improved.

[2] Each of the single-particles may have a first maximum diameter of, for example, more than or equal to 0.5 μm. The first maximum diameter represents a distance between two most distant points on a contour line of the single-particle. Each of the primary particles may have a second maximum diameter of, for example, less than 0.5 μm. The second maximum diameter represents a distance between two most distant points on a contour line of the primary particle.

When the single-particle has a larger particle size than that of the primary particle included in the aggregated particle, the balance between the input performance and the cycle life tends to be excellent.

[3] Each of the first positive electrode active material particle and the second positive electrode active material particle may independently include a lamellar metal oxide.

The lamellar metal oxide is represented by, for example, the following formula (1):

Li₁₋ₐNiₓMe₁₋ₓO₂ (1).

In the formula (1),

“a” satisfies a relation of −0.3≤a≤0.3.

“x” satisfies a relation of 0.7≤x≤1.0.

“Me” represents at least one selected from a group consisting of Co, Mn, Al, Zr, B, Mg, Fe, Cu, Zn, Sn, Na, K, Ba, Sr, Ca, W, Mo, Nb, Ti, Si, V, Cr, and Ge.

In the lamellar metal oxide of the formula (1), Ni has a large composition ratio (x). The lamellar metal oxide of the formula (1) is also referred to as “high-nickel material”. The high-nickel material can have a large specific capacity. However, the high-nickel material is greatly changed in volume due to charging/discharging, so that particles tend to be likely to be crushed. By applying the high-nickel material to the battery of the present disclosure, it is expected to reduce crushing of the particles in the high-nickel material.

[4] A ratio of a thickness of the first layer to a total of the thickness of the first layer and a thickness of the second layer may be, for example, 0.1 to 0.3.

In the description below, the ratio of the thickness (T1) of the first layer to the total (T1+T2) of the thickness of the first layer and the thickness of the second layer is also described as “first layer ratio” or “T1/(T1+T2)”. When the first layer ratio is 0.1 to 0.3, the balance between the input performance and the cycle life tends to be particularly excellent.

[5] The first particle group may have a mass fraction of, for example, 90% to 100% with respect to a whole of a positive electrode active material included in the first layer. The second particle group may have a mass fraction of, for example, 90% to 100% with respect to a whole of a positive electrode active material included in the second layer.

As the mass fraction of the first particle group in the first layer is higher and the mass fraction of the second particle group in the second layer is higher, the balance between the input performance and the cycle life tends to be more excellent.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic diagram showing an exemplary nonaqueous electrolyte secondary battery in the present embodiment.

FIG. 2 is a schematic diagram showing an exemplary electrode assembly in the present embodiment.

FIG. 3 is a conceptual diagram showing a positive electrode in the present embodiment.

FIG. 4 is an explanatory diagram of a method of measuring a thickness.

FIG. 5 is a graph showing a relation between a first layer ratio and battery performance.

### DESCRIPTION OF THE PREFERRED EMBODIMENTS

Hereinafter, an embodiment of the present disclosure (hereinafter, also referred to as “the present embodiment”) will be described. However, the scope of claims is not limited by the description below.

In the present specification, a numerical range such as “1 to 10” includes the lower and upper limit values unless otherwise stated particularly. For example, the description “1 to 10” represents a range of “more than or equal to 1 and less than or equal to 10”. Further, numerical values freely extracted from the numerical range may be employed as new lower and upper limit values. For example, a new numerical range may be set by freely combining a numerical value described in an example with a numerical value falling within the numerical range.

In the present specification, the description “consist essentially of” indicates that an additional component can be included in addition to an essential component to such an extent that the object of the present disclosure is not hindered. For example, a normally imaginable component in the technical field (such as an inevitable impurity) may be included as an additional component.

In the present specification, when a compound is expressed by a stoichiometric composition formula such as “LiCoO₂”, the stoichiometric composition formula merely indicates a representative example. For example, when a lithium cobaltate is expressed as “LiCoO₂”, the lithium cobaltate is not limited to a composition ratio of “Li/Co/O=1/1/2” unless otherwise stated particularly, and can include Li, Co, and O at any composition ratio. The composition ratio may be non-stoichiometric.

The geometric terms in the present embodiment (for example, the term “perpendicular” or the like) should not be interpreted in a strict sense. For example, the term “perpendicular” may be deviated to some extent from the strict definition of the term “perpendicular”. The geometric terms in the present specification can surely include, for example, a tolerance, an error, and the like in terms of design, operation, manufacturing, and the like.

<Nonaqueous Electrolyte Secondary Battery>

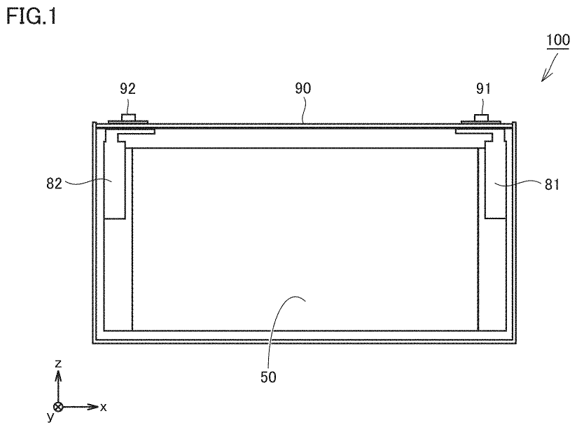

FIG. 1 is a schematic diagram showing an exemplary nonaqueous electrolyte secondary battery in the present embodiment.

Battery 100 can be used for any purpose of use. Battery 100 may be used as a main electric power supply or a motive power assisting electric power supply in an electrically powered vehicle, for example. A plurality of batteries 100 may be linked to form a battery module or a battery pack.

Battery 100 includes an exterior package 90. Exterior package 90 has a prismatic shape (flat rectangular parallelepiped shape). However, the prismatic shape is exemplary. Exterior package 90 may have, for example, a cylindrical shape or a pouch shape. Exterior package 90 may be composed of, for example, an aluminum alloy. Exterior package 90 stores an electrode assembly 50 and an electrolyte (not shown). Electrode assembly 50 is connected to a positive electrode terminal 91 by a positive electrode current collecting member 81. Electrode assembly 50 is connected to a negative electrode terminal 92 by a negative electrode current collecting member 82.

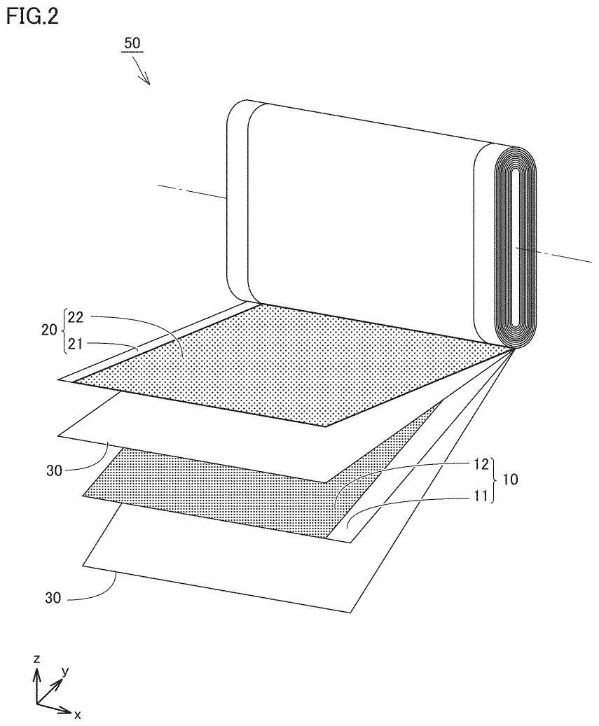

FIG. 2 is a schematic diagram showing an exemplary electrode assembly in the present embodiment.

Electrode assembly 50 is of a wound type. Electrode assembly 50 includes a positive electrode 10, separator(s) 30, and a negative electrode 20. That is, battery 100 includes a positive electrode 10, a negative electrode 20, and an electrolyte. Each of positive electrode 10, separator(s) 30, and negative electrode 20 is a sheet in the form of a strip. Electrode assembly 50 may include two separators 30. Electrode assembly 50 is formed by layering positive electrode 10, separator 30, and negative electrode 20 in this order and winding them spirally. Electrode assembly 50 is shaped to have a flat shape after the winding. It should be noted that the wound type is exemplary. Electrode assembly 50 may be, for example, of a stack type.

<<Positive Electrode>>

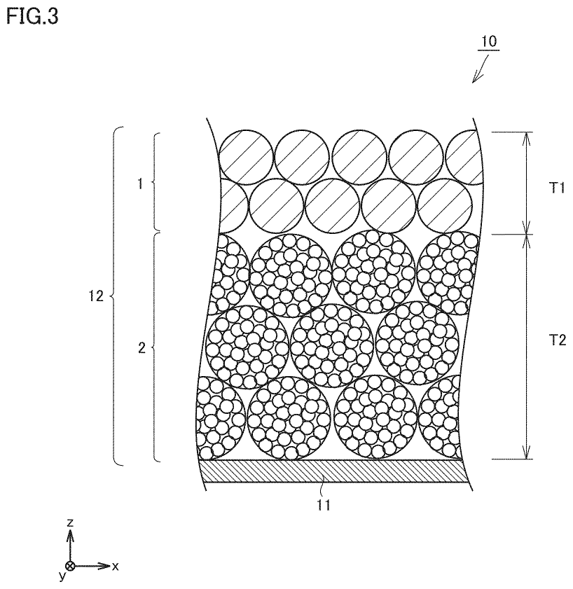

FIG. 3 is a conceptual diagram showing a positive electrode in the present embodiment.

Positive electrode 10 includes a positive electrode substrate 11 and a positive electrode active material layer 12. Positive electrode active material layer 12 is disposed on a surface of positive electrode substrate 11. Positive electrode active material layer 12 may be formed directly on the surface of positive electrode substrate 11. For example, an intermediate layer (not shown) may be formed between positive electrode active material layer 12 and positive electrode substrate 11. In the present embodiment, also when the intermediate layer is formed, positive electrode active material layer 12 is regarded as being disposed on the surface of positive electrode substrate 11. The intermediate layer may have a thickness smaller than that of positive electrode active material layer 12. The intermediate layer may include, for example, a conductive material, an insulating material, or the like. Positive electrode active material layer 12 may be disposed only on one side of positive electrode substrate 11. Positive electrode active material layer 12 may be disposed on each of the front and rear surfaces of positive electrode substrate 11.

(Positive Electrode Substrate)

Positive electrode substrate 11 is an electrically conductive sheet. Positive electrode substrate 11 may have a thickness of, for example, 10 μm to 30 μm. Positive electrode substrate 11 may include, for example, an Al foil or the like.

(Positive Electrode Active Material Layer)

Positive electrode active material layer 12 may have a thickness of, for example, 10 μm to 200 μm. Positive electrode active material layer 12 may have a thickness of, for example, 50 μm to 150 μm. Positive electrode active material layer 12 may have a thickness of, for example, 50 μm to 100 μm.

Positive electrode active material layer 12 includes a first layer 1 and a second layer 2. Positive electrode active material layer 12 may further include another layer as long as first layer 1 and second layer 2 are included therein. The other layer has a composition different from those of first layer 1 and second layer 2. For example, a third layer (not shown) may be formed between first layer 1 and second layer 2. For example, a fourth layer (not shown) may be formed between second layer 2 and positive electrode substrate 11. For example, a fifth layer (not shown) may be formed between the surface of positive electrode active material layer 12 and first layer 1.

(First Layer)

First layer 1 is an upper layer with respect to second layer 2. First layer 1 is disposed on the surface side of positive electrode active material layer 12 with respect to second layer 2. First layer 1 may form the surface of positive electrode active material layer 12, for example. First layer 1 includes a first particle group as a main active material. First layer 1 may further include another particle group (for example, a second particle group or the like) as long as the first particle group is included therein as the main active material.

The “main active material” in the present embodiment has the maximum mass fraction in the positive electrode active material included in the target layer. For example, when the positive electrode active material consists of a particle group a having a mass fraction of 40%, a particle group having a mass fraction of 30%, and a particle group y having a mass fraction of 30% in the target layer, particle group a is regarded as the main active material. For example, the main active material may have a mass fraction of more than or equal to 40%, a mass fraction of more than or equal to 50%, a mass fraction of more than or equal to 60%, a mass fraction of more than or equal to 70%, a mass fraction of more than or equal to 80%, a mass fraction of more than or equal to 90%, or a mass fraction of 100% with respect to the whole of the positive electrode active material included in the target layer. That is, the first particle group may have a mass fraction of, for example, 90% to 100% with respect to the whole of the positive electrode active material included in first layer 1.

(First Particle Group/First Positive Electrode Active Material Particles/Single-Particles)

The first particle group consists of the plurality of first positive electrode active material particles. Each of the first positive electrode active material particles can have any shape. The first positive electrode active material particle may have a spherical shape, a columnar shape, a lump-like shape, or the like, for example. The plurality of first positive electrode active material particles may have a first average particle size of, for example, 0.5 μm to 10 μm. The first average particle size is measured in a SEM (scanning electron microscope) image of the first particle group. The “average particle size” in the present embodiment represents an average value of the Feret diameter in the SEM image. The average value represents the arithmetic average of 100 or more particles. The plurality of first positive electrode active material particles may have a first average particle size of 1 μm to 5 μm, for example.

Each of the first positive electrode active material particles includes 1 to 10 single-particles. Each of the single-particles is a primary particle (single crystal) grown to be relatively large. The “single-particle” in the present embodiment represents a particle in which no grain boundary can be confirmed in its external appearance in the SEM image of the particle. Since there are a small number of grain boundaries, a crack tends to be less likely to be generated in the single-particle. The single-particle may have any shape. The single-particle may have a spherical shape, a columnar shape, a lump-like shape, or the like, for example. A single-particle may solely form a first positive electrode active material particle. 2 to 10 single-particles may be aggregated to form a first positive electrode active material particle.

The number of the single-particles included in the first positive electrode active material particle is measured in the SEM image of the first positive electrode active material particle. The magnification of the SEM image is appropriately adjusted in accordance with the size of the particle. The magnification of the SEM image may be, for example, 10000× to 30000×.

It should be noted that, for example, when two single-particles are overlapped with each other in the SEM image of the particle, the particle behind the other may not be confirmed. However, in the present embodiment, the number of single-particles that can be confirmed in the SEM image is regarded as the number of the single-particles included in the first positive electrode active material particle. The same applies to an aggregated particle described later. The first positive electrode active material particle may consist essentially of 1 to 10 single-particles, for example. The first positive electrode active material particle may consist of 1 to 10 single-particles, for example. The first positive electrode active material particle may consist of 1 to 5 single-particles, for example. The first positive electrode active material particle may consist of 1 to 3 single-particles, for example. The first positive electrode active material particle may consist of 1 single-particle, for example.

The single-particle has a first maximum diameter. The “first maximum diameter” represents a distance between two most distant points on a contour line of the single-particle. In the present embodiment, the “contour line of the particle” may be confirmed in a two-dimensional projection image of the particle, or may be confirmed in a cross sectional image of the particle. The contour line of the particle may be confirmed, for example, in a SEM image of the powder or in a cross sectional SEM image of the particle. The single-particle may have a first maximum diameter of more than or equal to 0.5 μm, for example. The single-particle may have a first maximum diameter of, for example, 3 μm to 7 μm. The average value of the first maximum diameters may be, for example, 3 μm to 7 μm. The average value is the arithmetic average of 100 or more single-particles. The 100 or more single-particles are extracted randomly.

(Second Layer)

Second layer 2 is disposed between first layer 1 and positive electrode substrate 11. Second layer 2 is a lower layer with respect to first layer 1. Second layer 2 is disposed on the positive electrode substrate 11 side with respect to first layer 1. Second layer 2 may be in contact with positive electrode substrate 11, for example. Second layer 2 may be formed on the surface of positive electrode substrate 11, for example. Second layer 2 includes a second particle group as a main active material. Second layer 2 may further include another particle group (for example, the first particle group or the like) as long as the second particle group is included therein as the main active material. That is, the second particle group may have a mass fraction of, for example, 90% to 100% with respect to the whole of the positive electrode active material included in second layer 2.

(Second Particle Group/Second Positive Electrode Active Material Particles/Aggregated Particles)

The second particle group consists of the plurality of second positive electrode active material particles. Each of the second positive electrode active material particles can have any shape. The second positive electrode active material particle may have a spherical shape, a columnar shape, a lump-like shape, or the like, for example. The plurality of second positive electrode active material particles may have a second average particle size of, for example, 5 μm to 20 μm. The second average particle size may be larger than the first average particle size. The second average particle size is measured in the SEM image of the second particle group. The plurality of second positive electrode active material particles may have a second average particle size of, for example, 8 μm to 16 μm.

Each of the second positive electrode active material particles includes an aggregated particle. The second positive electrode active material particle may consist essentially of an aggregated particle, for example. The second positive electrode active material particle may consist of an aggregated particle, for example. The aggregated particle is formed by aggregation of 50 or more primary particles (single crystal). In each primary particle included in the aggregated particle, the diffusion resistance for the Li ions tends to be small.

The number of the primary particles included in the aggregated particle is measured in a SEM image of the aggregated particle. The magnification of the SEM image may be, for example, 10000× to 30000×. The aggregated particle may be formed by aggregation of 100 or more primary particles, for example. There is no upper limit for the number of the primary particles in the aggregated particle. The aggregated particle may be formed by aggregation of 10000 or less primary particles, for example. The aggregated particle may be formed by aggregation of 1000 or less primary particles, for example. Each of the primary particles may have any shape. The primary particle may have a spherical shape, a columnar shape, a lump-like shape, or the like, for example.

The “primary particle” in the present embodiment represents a particle in which no grain boundary can be confirmed in its external appearance in the SEM image of the particle. The primary particle has a second maximum diameter. The “second maximum diameter” represents a distance between two most distant points on a contour line of the primary particle. The second maximum diameter of the primary particle may be smaller than the first maximum diameter of the single-particle, for example. Each of the primary particles may have a second maximum diameter of less than 0.5 μm, for example. The primary particle may have a second maximum diameter of 0.05 μm to 0.2 μm, for example. When each of 10 or more primary particles randomly extracted from the SEM image of one aggregated particle has a second maximum diameter of 0.05 μm to 0.2 μm, all the primary particles included in the aggregated particle can be regarded as each having a second maximum diameter of 0.05 μm to 0.2 μm. Each of the primary particles may have a second maximum diameter of, for example, 0.1 μm to 0.2 μm. The average value of the second maximum diameters may be 0.1 μm to 0.2 μm, for example. The average value represents the arithmetic average of 100 or more primary particles. The 100 or more primary particles are extracted randomly.

(Compositions of First and Second Positive Electrode Active Material Particles)

Each of the first positive electrode active material particle (single-particle) and the second positive electrode active material particle (aggregated particle) in the present embodiment can independently have any crystal structure. Each of the first positive electrode active material particle and the second positive electrode active material particle may independently have a lamellar structure, a spinel structure, an olivine structure, or the like, for example.

Each of the first positive electrode active material particle and the second positive electrode active material particle in the present embodiment can independently have any composition. The first positive electrode active material particle may have the same composition as that of the second positive electrode active material particle, for example. The first positive electrode active material particle may have a composition different from that of the second positive electrode active material particle, for example. For example, each of the first positive electrode active material particle and the second positive electrode active material particle may independently include at least one selected from a group consisting of LiCoO₂, LiNiO₂, LiMnO₂, LiMn₂O₄, Li(NiCoMn)O₂, Li(NiCoAl)O₂, and LiFePO₄. Here, for example, a description such as “(NiCoMn)” in a composition formula such as “Li(NiCoMn)O₂” indicates that the total of the composition ratios in the parentheses is 1.

Each of the first positive electrode active material particle and the second positive electrode active material particle may independently include a lamellar metal oxide, for example.

The lamellar metal oxide is represented by, for example, the following formula

Li₁₋ₐNiₓMe₁₋ₓO₂ (1).

In the formula (1),

“a” satisfies a relation of −0.3≤a≤0.3.

“x” satisfies a relation of 0.7≤x≤1.0.

“Me” represents at least one selected from a group consisting of Co, Mn, Al, Zr, B, Mg, Fe, Cu, Zn, Sn, Na, K, Ba, Sr, Ca, W, Mo, Nb, Ti, Si, V, Cr, and Ge.

For example, each of the first positive electrode active material particle and the second positive electrode active material particle may independently include at least one selected from a group consisting of LiNi_{0.8}Co_{0.1}Mn_{0.1}O₂, LiNi_{0.7}Co_{0.2}Mn_{0.1}O₂, LiNi_{0.7}Co_{0.1}Mn_{0.2}O₂, LiNi_{0.6}Co_{0.3}Mn_{0.1}O₂, LiNi_{0.6}Co_{0.2}Mn_{0.2}O₂, and LiNi_{0.6}Co_{0.1}Mn_{0.3}O₂.

For example, each of the first positive electrode active material particle and the second positive electrode active material particle may independently include at least one selected from a group consisting of LiNi_{0.8}Co_{0.1}Mn_{0.1}O₂, LiNi_{0.7}Co_{0.2}Mn_{0.1}O₂, and LiNi_{0.6}Co_{0.2}Mn_{0.2}O₂.

(Other Components)

In addition to the positive electrode active material, each of first layer 1 and second layer 2 further includes an additional component. Each of first layer 1 and second layer 2 may independently include a conductive material, a binder, and the like, for example. The conductive material can include any component. For example, the conductive material may include at least one selected from a group consisting of carbon black, graphite, vapor-grown carbon fiber (VGCF), carbon nanotube (CNT), and graphene flake. A blending amount of the conductive material may be, for example, 0.1 part by mass to 10 parts by mass with respect to 100 parts by mass of the positive electrode active material. The binder can include any component. For example, the binder may include at least one selected from a group consisting of polyvinylidene difluoride (PVdF), poly(vinylidene fluoride-co-hexafluoropropylene) (PVdF-HFP), polytetrafluoroethylene (PTFE), and polyacrylic acid (PAA). A blending amount of the binder may be, for example, 0.1 part by mass to 10 parts by mass with respect to 100 parts by mass of the positive electrode active material.

(First Layer Ratio, T1/(T1+T2))

The first layer ratio can have any value in a range of more than 0 and less than 1. The first layer ratio may be 0.05 to 0.9, for example. The first layer ratio may be 0.05 to 0.4, for example. The first layer ratio may be 0.1 to 0.3, for example. When the first layer ratio is 0.1 to 0.3, the balance between the input performance and the cycle life tends to be particularly excellent. The first layer ratio may be 0.1 to 0.2, for example. The first layer ratio may be 0.2 to 0.3, for example.

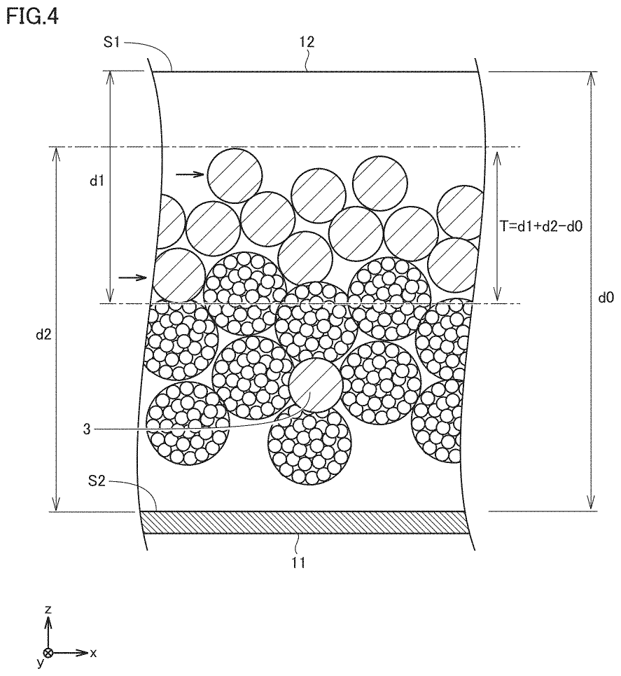

FIG. 4 is an explanatory diagram of a method of measuring a thickness.

In the present embodiment, the thickness (T1) of first layer 1 and the thickness (T2) of second layer 2 are measured as follows.

From positive electrode 10, 10 or more cross sectional samples are sampled. Each of the cross sectional samples is sampled from a randomly extracted position. The cross sectional sample includes a vertical plane perpendicular to the surface of positive electrode active material layer 12. Cross section processing is performed onto the cross sectional sample. The cross section processing may be CP (cross section polisher) processing, FIB (focused ion beam) processing, or the like, for example. Each of the cross sectional samples is observed by a SEM. Thus, 10 or more cross sectional SEM images are obtained.

In the cross sectional SEM image, a particle located at the most distant position from the surface (S1) of positive electrode active material layer 12 in the thickness direction (z axis direction) of positive electrode active material layer 12 among the particles included in the layer that is a measurement target is extracted. For example, when first layer 1 is the measurement target, a single-particle at the most distant position from the surface (S1) is extracted. For example, when second layer 2 is the measurement target, an aggregated particle at the most distant position from the surface (S1) is extracted. A minimum distance (d1) between the extracted particle and the surface (S1) is measured.

However, no isolated particle 3 is extracted. Isolated particle 3 refers to a particle surrounded by a different type of particles. For example, isolated particle 3 (single-particle) in FIG. 4 is surrounded by a different type of particles (aggregated particles). Isolated particle 3 may be a particle that has been moved during the cross section processing, for example.

In the cross sectional SEM image, a particle located at the most distant position from the surface (S2) of positive electrode substrate 11 in the thickness direction of positive electrode active material layer 12 among the particles included in the layer that is a measurement target is extracted. For example, when first layer 1 is the measurement target, a single-particle at the most distant position from the surface (S2) is extracted. For example, when second layer 2 is the measurement target, an aggregated particle at the most distant position from the surface (S2) is extracted. A minimum distance (d2) between the extracted particle and the surface (S2) is measured. It should be noted that no isolated particle 3 is extracted as with the case described above.

In the cross sectional SEM image, a minimum distance (d0) between the surface (S1) of positive electrode active material layer 12 and the surface (S2) of positive electrode substrate 11 is measured at any position. The thickness (T) of the layer that is the measurement target is calculated by the following formula: “T=d1+d2−d0”. When first layer 1 is the measurement target, the thickness (T1) of first layer 1 is calculated. When second layer 2 is the measurement target, the thickness (T2) of second layer 2 is calculated.

The first layer ratio [T1/(T1+T2)] is calculated in each of the 10 or more cross sectional SEM images. The arithmetic average of the 10 or more results of measurement is regarded as the first layer ratio.

(Mass Fraction of First Positive Electrode Active Material Particles)

For example, in the whole of positive electrode active material layer 12, the first positive electrode active material particles may have, for example, a mass fraction of 5% to 90%, a mass fraction of 5% to 40%, a mass fraction of 10% to 30%, a mass fraction of 10% to 20%, and a mass fraction of 20% to 30% with respect to the total of the first positive electrode active material particles and the second positive electrode active material particles.

<<Negative Electrode>>

Negative electrode 20 includes a negative electrode substrate 21 and a negative electrode active material layer 22. Negative electrode substrate 21 can include, for example, a copper foil or the like. Negative electrode active material layer 22 is disposed on a surface of negative electrode substrate 21. Negative electrode active material layer 22 includes negative electrode active material particles. Each of the negative electrode active material particles can include any component. The negative electrode active material particles may include, for example, at least one selected from a group consisting of graphite, soft carbon, hard carbon, Si, SiO, Si-based alloy, Sn, SnO, Sn-based alloy, and Li₄Ti₅O₁₂. In addition to the negative electrode active material particles, negative electrode active material layer 22 may further include a binder or the like. The binder may include, for example, styrene-butadiene rubber (SBR), carboxymethyl cellulose (CMC), or the like.

<<Separator>>

At least a portion of separator 30 is disposed between positive electrode 10 and negative electrode 20. Separator 30 separates positive electrode 10 and negative electrode 20 from each other. Separator 30 is porous. Separator 30 allows an electrolyte solution to pass therethrough. Separator 30 is electrically insulative. Separator 30 may be composed of, for example, polyolefin. It should be noted that when the electrolyte is a solid, the electrolyte may function as the separator.

<<Electrolyte>>

The electrolyte conducts ions and does not conduct electrons. The electrolyte may include at least one selected from a group consisting of a liquid electrolyte (electrolyte solution or ionic liquid), a gel electrolyte, and a solid electrolyte. In the present embodiment, the electrolytic solution is described as an example. The electrolyte solution includes a solvent and a supporting electrolyte. The electrolyte solution may further include any additive agent. The solvent is aprotic. For example, the solvent may include at least one selected from a group consisting of ethylene carbonate (EC), propylene carbonate (PC), ethyl methyl carbonate (EMC), dimethyl carbonate (DMC), and diethyl carbonate (DEC). The supporting electrolyte is dissolved in the solvent. The supporting electrolyte can include any component. For example, the supporting electrolyte may include at least one selected from a group consisting of LiPF₆, LiBF₄, and LiN(FSO₂)₂.

### Examples

The following describes an example of the present disclosure (hereinafter, also referred to as “the present example”). However, the scope of claims is not limited by the description below.

<Production of Nonaqueous Electrolyte Secondary Battery>

<<No. 1>>

The following materials were prepared.

First particle group: the particle form is the single-particle; the composition is LiNi_{0.8}Co_{0.1}Mn_{0.1}O₂

Second particle group: the particle form is the aggregated particle; the composition is LiNi_{0.8}Co_{0.1}Mn_{0.1}O₂

Conductive material: graphite

Binder: PVdF (powder form)

Dispersion medium: N-methyl-2-pyrrolidone (NMP)

Positive electrode substrate: Al foil

100 parts by mass of the first particle group, 1 part by mass of the conductive material, 0.9 part by mass of the binder, and an appropriate amount of the dispersion medium were mixed to prepare a first slurry. 100 parts by mass of the second particle group, 1 part by mass of the conductive material, 0.9 part by mass of the binder, and an appropriate amount of the dispersion medium were mixed to prepare a second slurry.

The second slurry was applied onto each of the surfaces (front and rear surfaces) of the positive electrode substrate and was dried, thereby forming the second layer. The first slurry was applied onto the surface of the second layer and was dried, thereby forming the first layer. In this way, the positive electrode active material layer was formed. A ratio of the coating weight (g/cm²) of the first layer to the total of the coating weight of the first layer and the coating weight of the second layer was 0.1. The positive electrode active material layer was rolled by a rolling roller. In this way, the positive electrode was produced. In the positive electrode active material layer after the rolling, the first layer ratio is considered to be 0.1. The positive electrode was cut into a predetermined planar size. Further, a battery including the positive electrode was produced.

<<No. 2>>

A positive electrode and a battery were produced in the same manner as in No. 1 except that the whole of the positive electrode active material layer was formed by the second slurry (aggregated particles).

<<No. 3>>

A positive electrode and a battery were produced in the same manner as in No. 1 except that the whole of the positive electrode active material layer was formed by the first slurry (single-particles).

<<No. 4>>

10 parts by mass of the first particle group, 90 parts by mass of the second particle group, 1 part by mass of the conductive material, 0.9 part by mass of the binder, and an appropriate amount of the dispersion medium were mixed to prepare a third slurry. A positive electrode and a battery were produced in the same manner as in No. 1 except that the whole of the positive electrode active material layer was formed by the third slurry.

<<No. 5 to No. 7>>

A positive electrode and a battery were produced in the same manner as in No. 1 except that the first layer ratio was changed as shown in Table 1.

<<No. 8 and No. 9>>

A positive electrode and a battery were produced in the same manner as in No. 1 except that the composition of the positive electrode active material particle was changed as shown in Table 1. It should be noted that in the column of the composition of Table 1, for example, the description “8/1/1” indicates that the relation “Ni/Co/Mn=8/1/1” in molar ratio is satisfied in Li(NiCoMn)O₂.

<<No. 10 and No. 11>>

A positive electrode and a battery were produced in the same manner as in No. 2 except that the composition of the positive electrode active material particle is changed as shown in Table 1.

<Evaluations>

<<Input Performance>>

Each battery was placed in a thermostatic chamber set at −10° C. The battery was charged by a constant current of 0.5 It. Thus, the SOC (state of charge) of the battery was adjusted to 50%. In the present example, an SOC of 100% represents a state in which a capacity corresponding to the initial capacity is charged. After the charging, the battery was left for 15 minutes. After being left, the battery was charged by a constant current of 0.1 It for 10 seconds. Voltage at a time after passage of 10 seconds from the start of charging was measured. Next, a capacity corresponding to the charging for 10 seconds was discharged. After the discharging, the current was changed, and the charging for 10 seconds and the measurement of voltage were performed again. For each of currents of 0.1 It to 2 It, voltage in the 10-second charging was measured in the same manner. Resistance was calculated in accordance with a relation between the current and the voltage. The resistance is shown in Table 1. It is considered that as the resistance is smaller, the input performance is more excellent.

It should be noted that “It” in the present example is a sign representing an hour rate of the current. For example, with a current of 1 It, the initial capacity of the battery is discharged in one hour.

<<Cycle Life>>

In a thermostatic chamber set at 60° C., 300 charging/discharging cycles of the battery were performed. One cycle represents one set of the following charging and discharging.

Charging: constant-current mode, current=0.5 It, end voltage=4.2 V

Discharging: constant-current mode, current=0.5 It, end voltage=2.5 V

A capacity retention ratio was calculated in accordance with the following formula: “capacity retention ratio (%)=(discharging capacity in the 300-th cycle/discharging capacity in the first cycle)×100”. The capacity retention ratio is shown in Table 1. It is considered that as the capacity retention ratio is higher, the cycle life is longer.

TABLE 1

| | Positive Electrode Active Material Layer | | | | | | |
|---|---|---|---|---|---|---|---|
| | First Layer | | Second Layer | | | | |
| | (Upper Layer) | | (Lower Layer) | | | | |
| | First Particle Group | | Second Particle Group | | | | |
| | First Positive Electrode | | Second Positive Electrode | | | Evaluations | |
| | Active Material Particles | | Active Material Particles | | | | Cycle Life |
| | (Single-Particles) | | (Aggregated Particles) | | | Input Performance | Capacity Retention |
| | | Mass | | Mass | First Layer Ratio | Resistance | Ratio |
| | Composition | Fraction¹⁾ | Composition | Fraction²⁾ | T1/(T1 + T2) | (−10° C., SOC 50%) | (60° C., 300cyc) |
| No. | Ni/Co/Mn | [%] | Ni/Co/Mn | [%] | [—] | [mΩ] | [%] |
| 1 | 8/1/1 | 10 | 8/1/1 | 90 | 0.1 | 473.8 | 78.4 |
| 2 | — | 0 | 8/1/1 | 100 | 0 | 430.8 | 70.9 |
| 3 | 8/1/1 | 100 | — | 0 | 1 | 905.5 | 78.5 |
| 4 | 8/1/1 | 10 | 8/1/1 | 90 | —³⁾ | 470.9 | 76.5 |
| 5 | 8/1/1 | 30 | 8/1/1 | 70 | 0.3 | 501.5 | 78.5 |
| 6 | 8/1/1 | 40 | 8/1/1 | 60 | 0.4 | 630.1 | 78.5 |
| 7 | 8/1/1 | 5 | 8/1/1 | 95 | 0.05 | 446.8 | 75.6 |
| 8 | 7/2/1 | 10 | 7/2/1 | 90 | 0.1 | 472.6 | 80.3 |
| 9 | 6/2/2 | 10 | 6/2/2 | 90 | 0.1 | 472 | 83.2 |
| 10 | 7/2/1 | 0 | 7/2/1 | 100 | 0 | 429.2 | 76.1 |
| 11 | 6/2/2 | 0 | 6/2/2 | 100 | 0 | 426.5 | 80.4 |

¹⁾represents the mass fraction of the first positive electrode active material particles with respect to the total of the first positive electrode active material particles and the second positive electrode active material particles included in the whole of the positive electrode active material layer.
²⁾represents the mass fraction of the second positive electrode active material particles with respect to the total of the first positive electrode active material particles and the second positive electrode active material particles included in the whole of the positive electrode active material layer.
³⁾In No. 4, a single layer is formed in which the first positive electrode active material particles and the second positive electrode active material particles are mixed.

<Results>

In view of the results of No. 1 to No. 4 in Table 1, it is observed that since the single-particles are collectively located in the upper layer (first layer) of the positive electrode active material layer and the aggregated particles are collectively located in the lower layer (second layer) of the positive electrode active material layer, the balance between the input performance and the cycle life tends to be improved. As compared with the case where the single-particles and the aggregated particles are simply mixed as in No. 4, desired performance is obtained when the single-particles are collectively located and the aggregated particles are collectively located in the thickness direction as in No. 1.

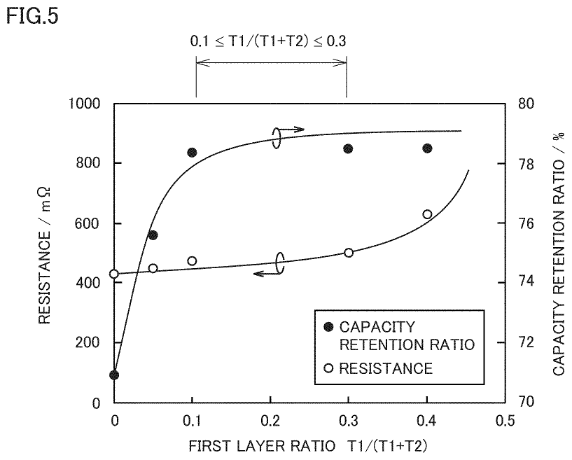

FIG. 5 is a graph showing a relation between the first layer ratio and the battery performance.

FIG. 5 shows results of No. 1, No. 2, and No. 5 to No. 7. In FIG. 5, it is observed that when the first layer ratio is 0.1 to 0.3, the balance between the input performance and the cycle life tends to be particularly excellent.

In the results of No. 8 to No. 11 in Table 1, it is observed that irrespective of the compositions of the positive electrode active material particles, the balance between the input performance and the cycle life tends to be improved by the single-particles being collectively located in the first layer and the aggregated particles being collectively located in the second layer.

The present embodiment and the present example are illustrative in any respects. The present embodiment and the present example are not restrictive. For example, it is initially expected to extract freely configurations from the present embodiment and the present example and combine them freely.

The technical scope defined by the terms of the claims encompasses any modification within the meaning equivalent to the terms of the claims. The technical scope defined by the terms of the claims also encompasses any modification within the scope equivalent to the terms of the claims.

What is claimed is:

1. A nonaqueous electrolyte secondary battery comprising:
a positive electrode;
a negative electrode; and
an electrolyte, wherein
the positive electrode includes a positive electrode substrate and a positive electrode active material layer,
the positive electrode active material layer is disposed on a surface of the positive electrode substrate,
the positive electrode active material layer includes a first layer and a second layer,
the second layer is disposed between the first layer and the positive electrode substrate,
the first layer includes a first particle group as a main active material,
the second layer includes a second particle group as a main active material,
the first particle group consists of a plurality of first positive electrode active material particles,
the second particle group consists of a plurality of second positive electrode active material particles,
each of the first positive electrode active material particles includes 1 to 10 single-particles, and
each of the second positive electrode active material particles is a secondary particle obtained by aggregation of 50 or more primary particles.

2. The nonaqueous electrolyte secondary battery according to claim 1, wherein
each of the single-particles has a first maximum diameter of more than or equal to 0.5 μm,
the first maximum diameter represents a distance between two most distant points on a contour line of the single-particle,
each of the primary particles has a second maximum diameter of less than 0.5 μm, and
the second maximum diameter represents a distance between two most distant points on a contour line of the primary particle.

3. The nonaqueous electrolyte secondary battery according to claim 1, 1 wherein
each of the first positive electrode active material particle and the second positive electrode active material particle independently includes a lamellar metal oxide,
the lamellar metal oxide is represented by the following formula (1):
Li₁₋ₐNiₓMe₁₋ₓO₂ (1),
where
a satisfies a relation of −0.3≤a≤0.3,
x satisfies a relation of 0.7≤x≤1.0, and
Me represents at least one selected from a group consisting of Co, Mn, Al, Zr, B, Mg, Fe, Cu, Zn, Sn, Na, K, Ba, Sr, Ca, W, Mo, Nb, Ti, Si, V, Cr, and Ge.

4. The nonaqueous electrolyte secondary battery according to claim 1, wherein a ratio of a thickness of the first layer to a total of the thickness of the first layer and a thickness of the second layer is 0.1 to 0.3.

5. The nonaqueous electrolyte secondary battery according to claim 1, wherein
the first particle group has a mass fraction of 90% to 100% with respect to a whole of a positive electrode active material included in the first layer, and
the second particle group has a mass fraction of 90% to 100% with respect to a whole of a positive electrode active material included in the second layer.
